(19) United States
(12) Patent Application Publication
(10) Pub. No.: US 2017/0161405 A1
(43) Pub. Date: Jun. 8, 2017

(54) Topology Optimization Using Reduced Length Boundaries On Structure Segments Of Different Thicknesses

(71) Applicants: THE REGENTS OF THE UNIVERSITY OF MICHIGAN, Ann Arbor, MI (US); IHI CORPORATION, Tokyo (JP)

(72) Inventors: Naoko Ishizuka, Tokyo (JP); Kazuhiro Saitou, Ann Arbor, MI (US); Takahiro Shimada, Tokyo (JP)

(21) Appl. No.: 15/368,225

(22) Filed: Dec. 2, 2016

Related U.S. Application Data
(60) Provisional application No. 62/262,807, filed on Dec. 3, 2015.

(51) Int. Cl. G06F 17/50

(52) U.S. Cl. CPC G06F 17/5004; G06F 17/5018

(57) ABSTRACT

A method and apparatus determines an optimal design of an engineered structure formed of segments having different thicknesses. The techniques include receiving a design model for the engineered structure. The design model includes a finite element model of a spatial domain wherein the engineered structure is contained and an objective function to be optimized. Based on satisfying a converged objective function value and a lower bound of material density values, the techniques are able to produce a completed model of the engineered structure.

### CROSS REFERENCE TO RELATED APPLICATION

This application claims the benefit of U.S. Provisional Application No. 62/262,807, filed Dec. 3, 2015, entitled “Topology optimization using reduced length boundaries on structure segments of different thicknesses,” which is hereby incorporated by reference in its entirety.

### FIELD OF INVENTION

The present disclosure generally relates to systems, methods, apparatus, and non-transitory media for performing topology optimizations in the design and analysis of engineered structures.

### BACKGROUND

The background description provided herein is for the purpose of generally presenting the context of the disclosure. Work of the presently named inventor, to the extent it is described in this background section or elsewhere herein, as well as aspects of the description that may not otherwise qualify as prior art at the time of filing, are neither expressly nor impliedly admitted as prior art against the present disclosure.

Topology and thickness distribution optimizations are often applied to engineered structures in order to improve their function or to reduce structure weight. However, conventional optimization methods merely rely on the designer's expertise, developed over years of trial and error. That expertise varies from structure to structure, which makes optimizations less than ideal, especially for structures having different layers or different materials. Conventional topology optimizations do not properly take into account the possibility of changes in thicknesses, for example. Moreover, because structural designs are completed before fabrication starts, a design that is initially sub-optimum is exceedingly difficult to ‘correct’ during fabrication.

### SUMMARY

The present application describes techniques for topology optimization in which topology and thickness distribution are optimized through algorithm-based (executable) processes. Topology, thickness, and any other design parameters may be optimized simultaneously using the present techniques. The ability to optimize both together makes it possible to obtain more efficient shapes that operate better (e.g., greater rigidity) from a structural point of view. It also allows for the creation of complex structures having segments, layers, and thicknesses that would not be achievable at the design stage, using conventional techniques. By iteratively increasing the lower bound, the algorithm can produce topology with arbitrary cut-off density (i.e. minimum plate thickness).

In accordance with an example, a computer implemented method for determining an optimal design of an engineered structure formed of segments having different thicknesses, the method comprises: (a) receiving a design model for the engineered structure, the design model including (i) a finite element model of a spatial domain wherein the engineered structure is contained and (ii) an objective function to be optimized, wherein the finite element model defines an adjustable material density that represents material density values for each of the segments forming the engineered structure, wherein the objective function defines (i) an external load bearing ability of the engineered structure, as a function of a material density value, and (ii) segment boundary lengths for boundary regions between adjacent segments forming the engineering structure, as a function of a material density value; (b) executing a finite element method to solve equilibrium conditions for the finite element model, wherein the equilibrium conditions define an acceptable range of material density values for each of the segments, where the acceptable range of material density values correspond to an acceptable range of thicknesses for each of the segments; (c) determining a converged objective function value for the finite element model; (d) determining if the converged objective function value results in material density values for each of segment that correspond to the acceptable range of thicknesses; (e) if the converged objective function value corresponds to the acceptable range of thicknesses, determining if a lower bound of the material density values of the segments reaches a lower bound of the acceptable range of material density values; (f) if the lower bound of the material density values does not reach the lower bound of the acceptable range of material density values, then adjusting the lower bound of the material density values until the lower bound of the acceptable range is reached and performing (b)-(f) until the lower bound of the material density values corresponds to the lower bound of the acceptable range of material density values; and (g) if the converged objective function value is given by material density values that correspond to the acceptable range of material density values and if the lower bound of the material density values corresponds to the lower bound of the acceptable range, then producing a completed model of the engineered structure, the completed model including the segments and thicknesses of each of the segments.

In accordance with another example, an apparatus comprises: one or more processing units and one or more memories storing instructions that when executed by the one or more processing units, cause the one or more processing units to: (a) receive a design model for an engineered structure formed of segments having different thicknesses, the design model including (i) a finite element model of a spatial domain wherein the engineered structure is contained and (ii) an objective function to be optimized, wherein the finite element model defines an adjustable material density that represents material density values for each of the segments forming the engineered structure, wherein the objective function defines (i) an external load bearing ability of the engineered structure, as a function of a material density value, and (ii) segment boundary lengths for boundary regions between adjacent segments forming the engineering structure, as a function of a material density value; (b) execute a finite element method to solve equilibrium conditions for the finite element model, wherein the equilibrium conditions define an acceptable range of material density values for each of the segments, where the acceptable range of material density values correspond to an acceptable range of thicknesses for each of the segments; (c) determine a converged objective function value for the finite element model; (d) determine if the converged objective function value results in material density values for each of segment that correspond to the acceptable range of thicknesses; (e) if the converged objective function value corresponds to the acceptable range of thicknesses, determine if a lower bound of the material density values of the segments reaches a lower bound of the acceptable range of material density values; (f) if the lower bound of the material density values does not reach the lower bound of the acceptable range of material density values, then adjust the lower bound of the material density values until the lower bound of the acceptable range is reached and perform (b)-(f) until the lower bound of the material density values corresponds to the lower bound of the acceptable range of material density values; and (g) if the converged objective function value is given by material density values that correspond to the acceptable range of material density values and if the lower bound of the material density values corresponds to the lower bound of the acceptable range, then produce a completed model of the engineered structure, the completed model including the segments and thicknesses of each of the segments.

### BRIEF DESCRIPTION OF THE DRAWINGS

The figures described below depict various aspects of the system and methods disclosed herein. It should be understood that each figure depicts an example of aspects of the present systems and methods.

FIG. 1 illustrates an example topology optimization system, in accordance with an example.

FIG. 2 is a flow diagram of an example topology optimization process as may be executed by the system of FIG. 1.

FIG. 3 illustrates an example topology optimization process over multiple iterations.

FIG. 4A illustrates an example Messerschmitt-Bolkow-Blohm (MBB) beam. FIGS. 4B and 4C illustrate an example resulting topology optimization for that MBB beam, in accordance with an example.

FIGS. 5A, 5B, and 5D illustrate examples of a topology optimization for a liquefied natural gas (LNG) tank, in accordance with an example. FIG. 5C is a plot of convergence of the topology optimization of FIGS. 5A, 5B, and 5D.

### DETAILED DESCRIPTION

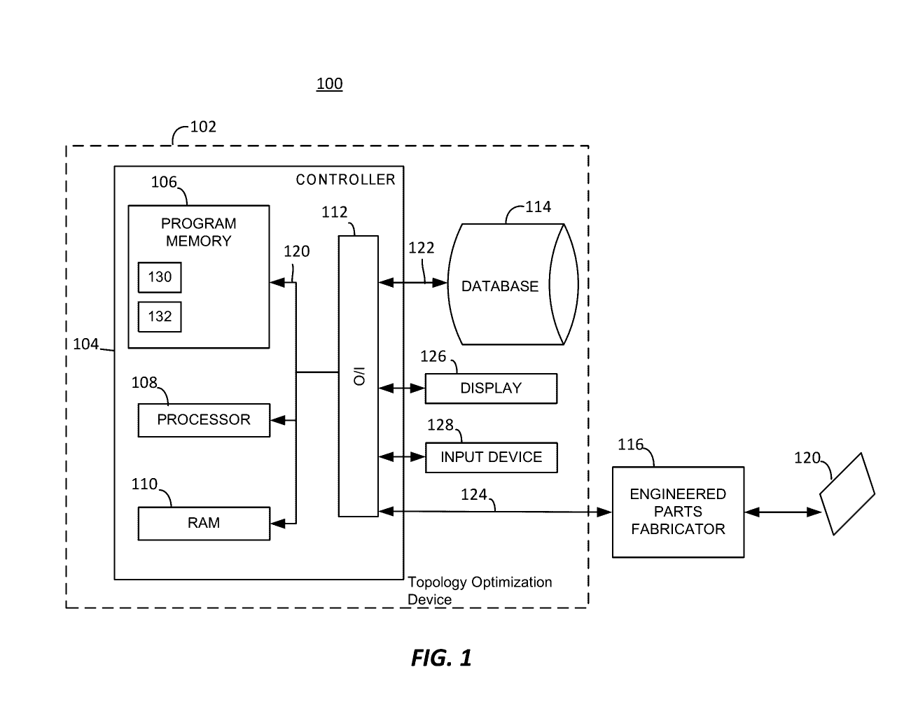

FIG. 1 illustrates an example topology optimization system 100 illustrating various components used in implementing techniques described herein. A topology optimization device 102 is coupled to engineered structure fabricator device 116, which may be, by way of example, an cutting machine, a lathe, an automated milling machine, etching machine, welding machine, multi-axis computerized numerical control (CNC) machine, three-dimensional (3D) printer, a surface treatment facility, or some combination of one or more of these. The fabricator 116 may be fully automated or partially automated. In either case, the system 100 is described as a fabricating system (or a system in fabrication mode). As such, the fabricator 116 receives instructions from the optimization device 102 and executes those instructions to form an engineered structure 120.

In some examples, the system 100 may operate in an analysis mode in which the fabricator 116 includes an analyzer device that examines the topology of an already formed engineered structure. In the analysis mode, the system 100 analyzes the engineered structure 120 to determine its structural layering, thicknesses, and segment sizes from which the system 100 can determine if the structure 100 has been fabricated according to an optimized model or not. The fabricator 116 may be a dual (or multi) mode device that includes both fabrication and analysis modes. Or the fabricator can be removed completely, and the fabricator 116 in FIG. 1 would represent a parts analyzer, e.g., a micrometer, a laser length measurement machine, an optical scanning or optical imaging device, scanning microscope, etc.

The topology optimization device 102 may have a controller 104 operatively connected to a database 114 via a link 122 connected to an input/output (I/O) circuit 112. It should be noted that, while not shown, additional databases may be linked to the controller 104 in a known manner. The controller 104 includes a program memory 106, the processor 108 (may be called a microcontroller or a microprocessor), a random-access memory (RAM) 110, and the input/output (I/O) circuit 112, all of which are interconnected via an address/data bus 120. It should be appreciated that although only one microprocessor 108 is shown, the controller 104 may include multiple microprocessors 108. Similarly, the memory of the controller 104 may include multiple RAMs 110 and multiple program memories 106. Although the I/O circuit 112 is shown as a single block, it should be appreciated that the I/O circuit 112 may include a number of different types of I/O circuits. The RAM(s) 110 and the program memories 106 may be implemented as semiconductor memories, magnetically readable memories, and/or optically readable memories, for example. A link 124 may operatively connect the controller 104 to the fabricator 116, through the I/O circuit 112.

The program memory 106 and/or the RAM 110 may store various applications (i.e., machine readable instructions) for execution by the microprocessor 108. For example, an operating system 130 may generally control the operation of the topology optimization device 102 and provide a user interface to the device 102 to implement the processes described herein. The program memory 106 and/or the RAM 110 may also store a variety of subroutines 132 for accessing specific functions of the topology optimization device 102. By way of example, and without limitation, the subroutines 132 may include, among other things: a subroutine for providing machining and fabrication instructions to the fabricator 116; a subroutine for receiving a design model for the engineered structure; a subroutine for determining a converged objective function value based on the design model; a subroutine for determining, using the design model, thicknesses for the segments to form the engineered structure; a subroutine for determining if a converged objective function value is achieved; a subroutine for, if the converged objective function value is not achieved, adjusting a design model parameter or parameters and or adjusting a lower bound of the allowable thickness range; and a subroutine for when convergence is achieved and producing an optimized model of the engineered structure, including segments, segment boundaries, and thicknesses.

The subroutines 132 may include other subroutines, for example, implementing software keyboard functionality, interfacing with other hardware in the device 102, etc. The program memory 106 and/or the RAM 110 may further store data related to the configuration and/or operation of the topology optimization device 102, and/or related to the operation of one or more subroutines 132. For example, the data may be data gathered from the system 116, data determined and/or calculated by the processor 108, etc.

In addition to the controller 104, the topology optimization device 102 may include other hardware resources. The device 102 may also include various types of input/output hardware such as a visual display 126 and input device(s) 128 (e.g., keypad, keyboard, etc.). In an embodiment, the display 126 is touch-sensitive, and may cooperate with a software keyboard routine as one of the software routines 132 to accept user input. It may be advantageous for the topology optimization device to communicate with a broader network (not shown) through any of a number of known networking devices and techniques (e.g., through a computer network such as an intranet, the Internet, etc.). For example, the device may be connected to a database of topology information, a database of engineering materials information, a database of parameters for engineered structures, database of standards for die steel. Accordingly, the disclosed embodiments may be used as part of an automated closed loop system fabrication system with embedded topology optimization. In most examples, herein the techniques are described in reference to a stand-alone system.

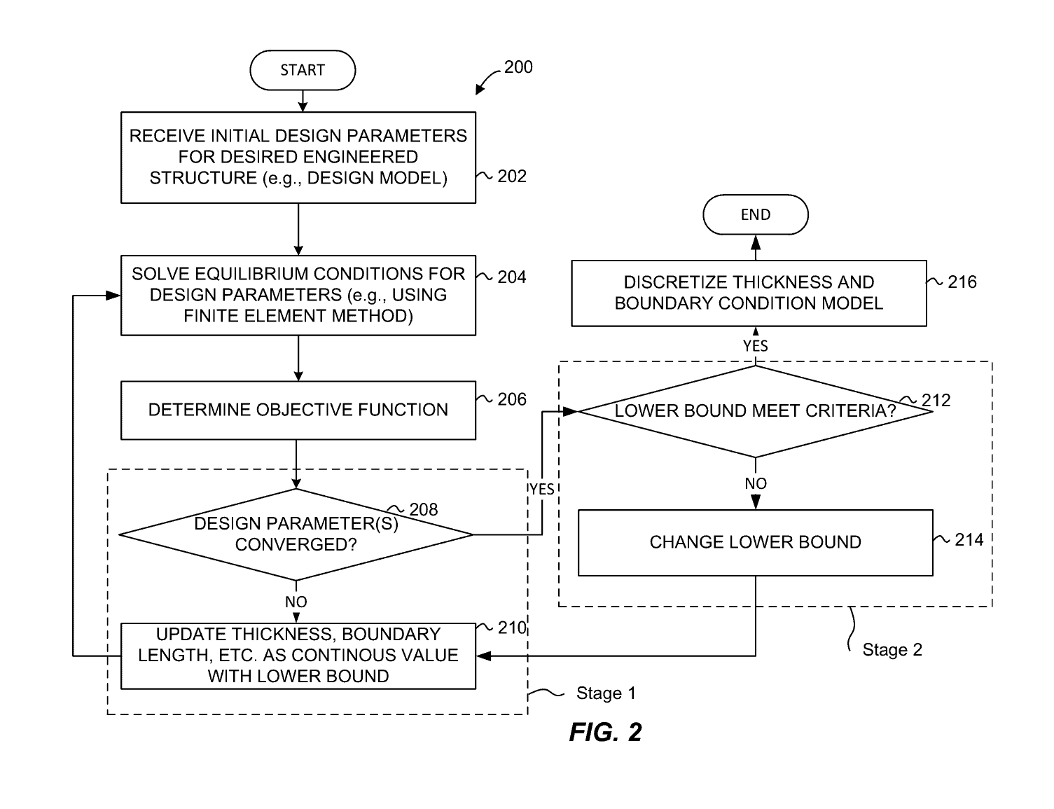

FIG. 2 illustrates a process 200 as may be implemented by the topology optimization system 100, in particular using executable subroutine instructions stored in the subroutines 132. Initially, at a block 202, the system 100 receives data corresponding to initial design parameters of an engineered structure. For example, the system 100 may receive a design model for an engineered structure, where that design model is stored in the database 114 in a design models database. In other examples, the block 202 may receive parameter data for the engineered structure and develop the design model itself.

The design model may include segment boundary lengths data for the boundary regions between adjacent segments forming the structure. The design model may include shape data describing the shape for each segment (e.g. plate), and thickness data for each segment.

The design model is formed having a finite element model of a spatial domain within which the engineered structure is contained. The finite element model may define an adjustable material density that represents material density values for each of the segments forming the engineered structure in that spatial domain.

The design model may also be formed having an objective function that the system 100 will optimize. The objective function itself may define a number of properties. The objective function, for example, may define an external load bearing ability of the engineered structure, as a function of a material density value. The objective function may also define segment boundary lengths for boundary regions between adjacent segments forming the engineering structure, where these boundary regions are also characterized as a function of a material density value. As discussed, describing features in terms of material density value allows the present techniques to overcome deficiencies in conventional modeling techniques.

In any event, the engineered structure may be characterized by size, boundary conditions, structural strength requirements (e.g., rigidity, tensile strength, yield strength, flexure, and allowable eigenfrequency). The engineered structure may be described as formed of different material segments that are to be combined, where those segments are defined with exact boundary/edge states or with flexible/adjustable ranges of boundary/edge states. Yet, in many examples, the number of segments to form the engineering structure is determined by the system 100, and specifically the topology optimization controller 104. As explained further below, that controller 104, implementing the techniques herein, may determine segment sizes, edges, edge lengths, boundary conditions with other segments and segment edges, as well as segment thicknesses.

The system 100, at a block 204, takes the design model and solves equilibrium equations, for example, using a finite element method—although any numerical analysis method may be suitable. The system 100 then determines a value or values for the objective function (block 206) for the current optimization iteration of the process 200, where the objective function value is determined as a material density value. Quantity of state is determined as an objective function by a designer to improve product features. In some implementations, if there are several features to improve, only the more valued one or ones of the multivariate function may be chosen for optimization. These features may be predetermined, for example.

The process 200 then determines (block 208) if the objective function value has converged to a desired value. If not, then the process 200 updates the corresponding values of the design model, and in particular the objective function at a block 210, and returns control to the block 204 for re-solving the equilibrium equations for the updated design model and the process repeats. For the next iteration, for example, at the block 208, the process 200 determines whether the design model parameters have converged to their desired values. When using an objective function value that has a material density value corresponding to a thickness value of the segments forming the engineered structure, convergence is performed on the thickness of each segment. The process 200 determines if the material density values correspond to a determined thickness value within an allowable range set by the system 100. If so, convergence has occurred on the objective function. If not, there is no convergence; and the process revises the parameters of the design model and repeats.

At the block 208, the process 200 may check for convergence on any number of parameters making up the design model. For example, the block 208 may perform a convergence check on the boundary lengths on the segments. The block 208 may determine, each optimization iteration, whether each of the boundary lengths are within an allowable boundary length range. In one example, in order to determine if the converged objective function value corresponds to the boundary lengths within the acceptable boundary length range, the process 200 may apply a mesh filter to the material density values (see, Rozvany, G I. N, and Niels Olhoff. Topology Optimization of Structures and Composite Continua. Dordrecht: Kluwer Academic Publishers, pp. 152-153, 2000). In this example, the mesh filter may be applied to the material density values to reduce a checker board pattern that emerges when an outline length is excluded from the boundary lengths using a differentiable approximate function of a step function (see, Diaz, A., Sigmund, O., Checkerboard patterns in layout optimization, Structural and Multidisciplinary Optimization, 10, pp. 40-45, 1995). The differentiable approximate step function may be selected from a sigmoid function, Fourier series, or a polynomial expression. If the converged objective function value corresponds to boundary lengths within the acceptable boundary length range, the process 200 may further determine if a lower bound of the boundary lengths reaches a lower bound of the acceptable boundary length range. If the boundary lengths do not converge to a desired value, then the process updates the design model boundary lengths (block 210) and repeats.

As noted, any of the parameters defining the design model may be simultaneously measured for convergence, in this way (e.g., boundary numbers, boundary lengths, segment thicknesses, etc.). The iterations used to converge the process 200 at the block 208 may be considered Stage 1 optimization, with another set of iterations forming a Stage 2 optimization.

If the objective function value(s) converges (block 208), i.e., the end of Stage 1 optimization, then the process 200 determines if a lower bound of the thicknesses used for the convergence determination meets a rigidity requirement (block 212), i.e., the Stage 2 optimization. If not, then the lower bounds used for the convergence determinations are changed (block 214), for example, by adjusting the lower bounds upward, and control is passed to the block 210 which may then adjust the thicknesses or other parameters, in a continuous manner, to adjust the design model, for the next optimization iteration. If the lower bound does not reach the allowable lower bound, the lower bound is slided a certain small amount upperward (block 214).

If the lower bound does meet the requirements (block 212), then the topology optimization is complete and optimized discretized thicknesses and optimized boundaries for the entire engineered structure are provided as an output model 216.

The output model 216 reflects a completed, topology optimized model of the engineered structure, and may be formatted as instructions consumable by the fabricator 116 to engineer the desired structure 120.

In this way, the process 200 reflects the operation of a topology optimization protocol of the system 100. The process 200 repeats, iteration after iteration, optimizing the objective function parameters for each segment of forming the engineered structure. For each iteration, the process 200 determines the boundary lengths of the segments (i.e., the lengths of the boundaries between adjacent segments), the number of boundaries for each segment (i.e., the number of edges on the segments), and the thicknesses of each segment, until the appropriate parameters are satisfied and the entire topology is optimized. Density corresponds to thickness. Therefore, if plate is modeled with allowable maximum thickness and density is 1, intermediate thicknesses are interpolated linearly. Boundary length may be expressed as an integration of density's gradient divided by density difference.

In some examples, the convergence process of block 208 is implemented using an imposed minimum value for thicknesses on the segments, e.g., plates, forming the engineered structure. Thickness topology optimization is achieved on each of the segments simultaneously, which means that a structure may be formed of multiple plates with multiple thicknesses and be optimized through a single iterative process.

The present techniques are able to reduce the lengths of boundaries between plates, in particular between plates of different thicknesses. Using plates of different topological thicknesses allows designers to create a much greater mosaic of structure types. The present techniques are able to provide this advantage, but they also take this concept further by optimizing the boundaries between plates of different thicknesses. This optimization can be done to reduce the costs of cutting and welding plates, as these costs are proportional to the length of the boundaries between the plates with different thicknesses. In some examples, this boundary optimization allows designers to reduce the number (or lengths) of weld boundaries between plates of different thicknesses. In other examples, this boundary optimization allows designers to increase the number (or lengths) of weld boundaries between plates of different thicknesses. In some examples, this reduction or increase may be performed only on plates having a threshold difference in height. Plates of similar heights may be less optimized in terms of boundary optimizations, compared to plates of large differences in height. Various minimization and/or maximization algorithms, such as sequential linear programming or the method of moving asymptotes, may be used to affect the desired the optimization. The boundaries may be optimized based on structural factors from the design model (desire size, strength, etc.), based on external factors (such as fabrication costs, including weld costs), based on material availability, or combinations of these and other factors.

The present techniques are also able to optimize the thicknesses on the plates and the distribution of those plates during the topology formation of structures made of plates with multiple thicknesses. The techniques may minimize plate thicknesses for each plate, for specific plates, for plates of a desired maximum thickness, for plates of a desired minimum thickness, or based on other design metrics.

The optimizations herein may be implemented, in some examples, using an executable algorithm model implementing a modified version of a solid isotropic material with penalization (SIMP) structural topology optimization (see, Bendsøe, M. P., Sigmund, O., Material interpolation schemes in topology optimization, Archive of Applied Mechanics, 69, pp. 635-654, 1999). In an example, the SIMP model is modified to include a distribution of material density with a penalty of 1 (penalty=1). The penalty provides a focal point for optimization, but uncharacteristically of prior art techniques, the penalty is used as a proxy (or corollary) of plate thicknesses, in particular the distribution of plate thicknesses. Using this constrained penalty model provides an effective topology optimization. However, in some examples, the resulting topology may contain large regions with very low density, and that can correspond to very thin plates that are often infeasible or uneconomical to manufacture. Therefore, the present techniques may also further optimize the thicknesses of the plates, by providing an algorithm that imposes a lower bound in feasible material density and does so in an iterative manner during the optimization, as discussed in relation to the process of in FIG. 2. By iteratively increasing the lower bound, the optimization device produces topology with arbitrary cut-off density (i.e. minimum plate thickness) with small sacrifice in the structural performance compared to the optimal topology without cut-off.

The process of optimization can be based on an algorithm that uses the difference in density, which is alternated with an evaluation of differences in thickness, which correlates to the densities. An example optimization expression is Min(Max) Obj=original state+boundary expression. The original state may be determined from the initial model (e.g., strain energy) and the boundary expression is the evaluation formula to be optimized over iterations.

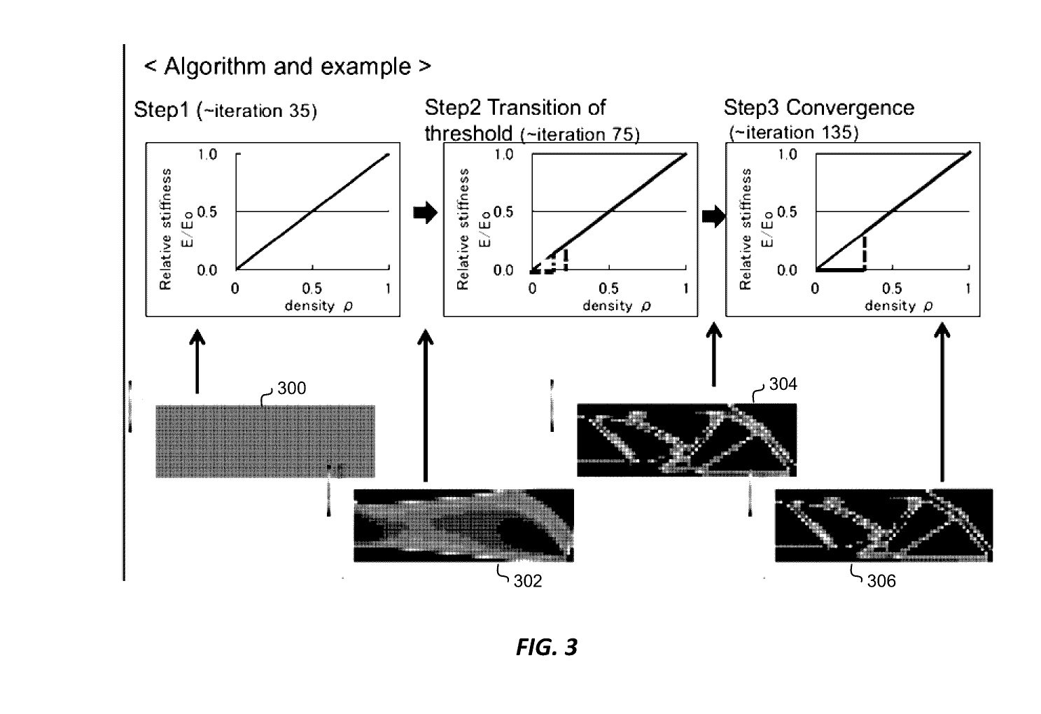

FIGS. 3-5 provide various optimization examples using the techniques herein. FIG. 3 illustrates an optimization process optimizing plate boundaries to a minimum optimization thickness over approximation 135 optimization iterations. At a step 1, an engineered structure model 300 is modeled initially as a single plate, single plate-thickness structure model. Over iterations, the structure model 300 begins converting to a structure model 302 that is formed of plats of different thicknesses, reflected by different densities of the different thicknesses. Using techniques such as that described in FIG. 2, the optimization converts the structure model 302 into a structure model 304, having further defined plates, instead of one plate as in structure model 300, but now six or more plates of different thicknesses in structure model 304. The optimization continues until convergence is achieved resulting in the final optimized topology structure 306. The density, and thus the thickness minimization, is bound by a relationship as shown in the plots of FIG. 3.

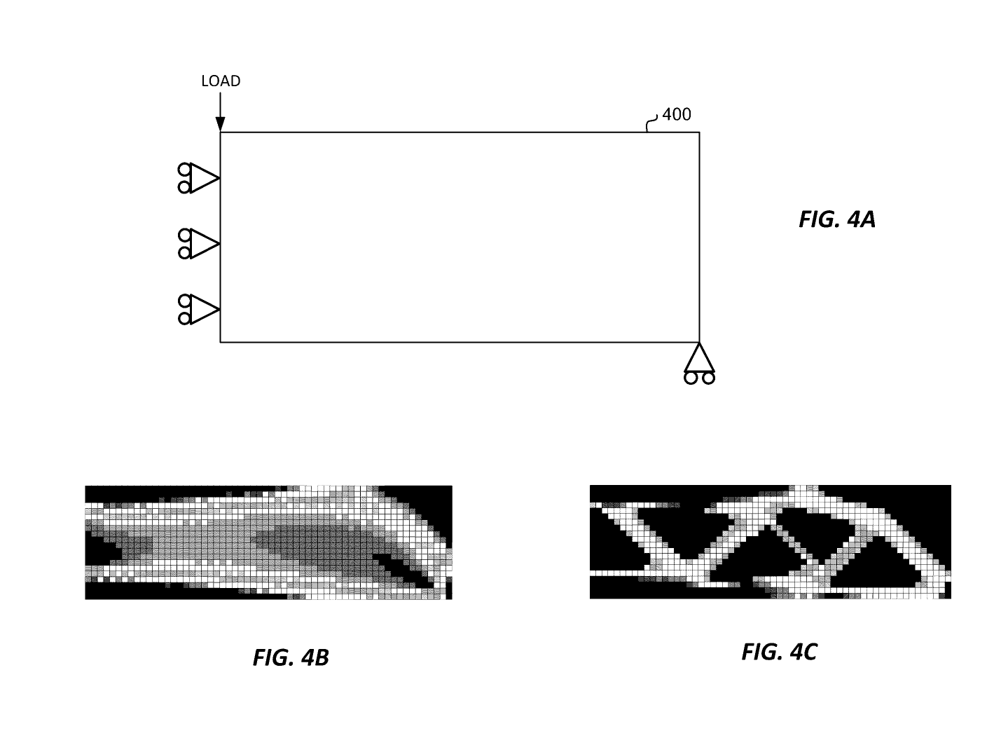

FIGS. 4A-4C illustrate an example optimization over many optimization iterations and for both Stage 1 and Stage 2 optimizations for an example design model and structure, specifically that of a Messerschmitt-Bolkow-Blohm (MBB) beam 400 with particular load constraints. The beam 400 has a dimension of 60×20 with a Young's modulus, E₀=1. The weight in the objection function is 0.1 and 0.3. FIGS. 4B and 4C illustrate the optimizations for the result model after Stage 1 and Stage 2, respectively. Table 1 provides the resulting optimization results.

TABLE 1
Optimization result

| | w = 0.0 | w = 0.1 | w = 0.3 | Penalty = 3 |
|---|---|---|---|---|
| Compliance | 190.8 | 212.7 | 225.9 | 254.0 |
| Perimeter | 228.8 | 339.4 | 269.1 | 379.6 |

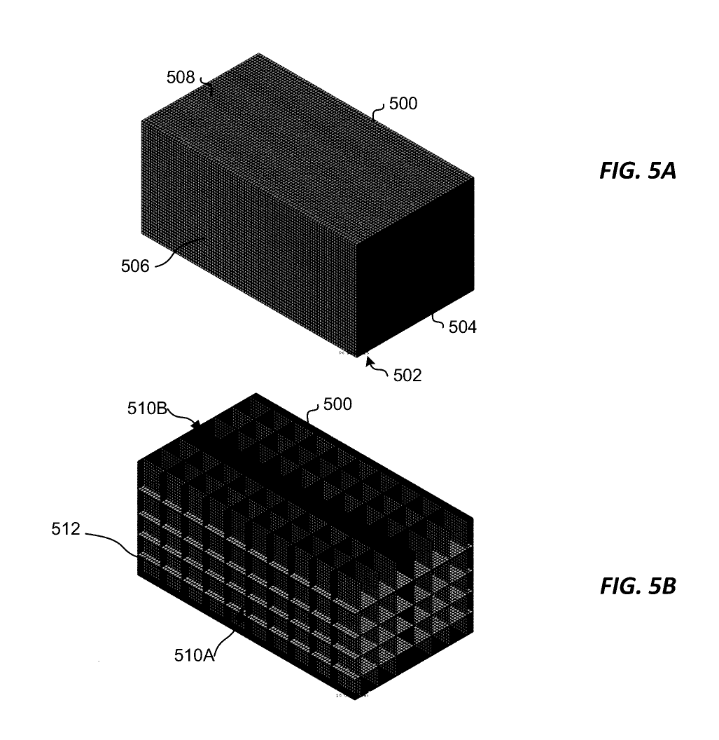

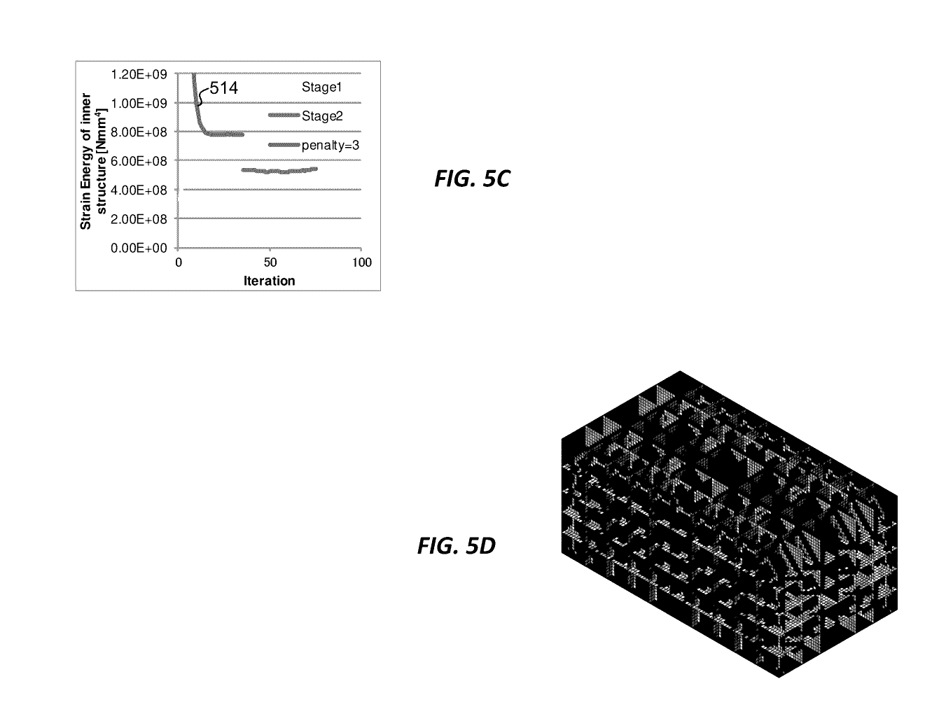

FIGS. 5A-5D illustrate an example formation of an optimized model for a liquefied natural gas (LNG) tank 500. FIG. 5A illustrates a volume and the perimeter conditions of the volume, with a fixed bottom surface 502 and a length of 55,000 mm. The LNG tank 500 comprises the outer surfaces 502, 504, 506, 508, etc., as well as vertical wall support 510A and 510B extending from pairs of opposing outer walls. The LNG tank 500 may comprise a series of horizontally extending walls 512 (only one has been labeled), as well. The initial model of the LNG tank 500 identifies that internal pressure will be applied by the liquid contents within the tank, as well as by the conditions related to the support walls 510A and 510B. The thicknesses for the walls 502, et seq. will be 30 mm for each. The tank 500 comprises an inner structure formed of cells of equal size extending throughout the inner volume. Each cell is defined by horizontal extending surfaces and vertically extending surfaces. The optimization device performs an optimization on these internal structure surfaces using a finite element mesh analysis, where the mesh is 600 mm a side in size for the illustrated example. FIG. 5C is a plot of the optimization process producing the optimized LNG tank model shown in FIG. 5D. The optimization process is shown as a plot of strain energy for the inner structure as a function of optimization iteration. The optimization for Stage 1 is shown as is the optimization for Stage 2. As shown, the majority of the strain energy optimization occurs in stage 1 and in less than 10 iteration cycles. Before 100 iteration cycles, the optimization from both stages is complete. Line 514 represents the case in which penalty is set to 3 which is conventional topology optimization. This case doesn't allow intermediate thickness distribution and determine only topology. It converges to higher strain energy which means the structure don't have rigidity compared to the structure which is allowed intermediate thickness distribution.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of the example methods described herein may be performed, at least partially, by one or more processors that are temporarily configured (e.g., by software) or that are permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or by processor-implemented hardware modules. The performance of certain of the operations may be distributed among the one or more processors, not only residing within a single machine (having different processing abilities), but also deployed across a number of machines. In some example embodiments, the processors may be located in a single location (e.g., deployed in the field, in an office environment, or as part of a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes on a GPU thread that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as an example only and does not describe every possible embodiment, as describing every possible embodiment would be impractical, if not impossible. One could implement numerous alternate embodiments, using either current technology or technology developed after the filing date of this application.

What is claimed:

1. A computer implemented method for determining an optimal design of an engineered structure formed of segments having different thicknesses, the method comprising:
(a) receiving a design model for the engineered structure, the design model including (i) a finite element model of a spatial domain wherein the engineered structure is contained and (ii) an objective function to be optimized,
wherein the finite element model defines an adjustable material density that represents material density values for each of the segments forming the engineered structure,
wherein the objective function defines (i) an external load bearing ability of the engineered structure, as a function of a material density value, and (ii) segment boundary lengths for boundary regions between adjacent segments forming the engineering structure, as a function of a material density value;
(b) executing a finite element method to solve equilibrium conditions for the finite element model, wherein the equilibrium conditions define an acceptable range of material density values for each of the segments, where the acceptable range of material density values correspond to an acceptable range of thicknesses for each of the segments;
(c) determining a converged objective function value for the finite element model;
(d) determining if the converged objective function value results in material density values for each of segment that correspond to the acceptable range of thicknesses;
(e) if the converged objective function value corresponds to the acceptable range of thicknesses, determining if a lower bound of the material density values of the segments reaches a lower bound of the acceptable range of material density values;
(f) if the lower bound of the material density values does not reach the lower bound of the acceptable range of material density values, then adjusting the lower bound of the material density values until the lower bound of the acceptable range is reached and performing (b)-(f) until the lower bound of the material density values corresponds to the lower bound of the acceptable range of material density values; and
(g) if the converged objective function value is given by material density values that correspond to the acceptable range of material density values and if the lower bound of the material density values corresponds to the lower bound of the acceptable range, then producing a completed model of the engineered structure, the completed model including the segments and thicknesses of each of the segments.

2. The computer implemented method of claim 1, wherein producing the completed model of the engineered structure further comprises producing the completed model to include segment boundary lengths for the boundary regions between adjacent segments.

3. The computer implemented method of claim 2, wherein producing the completed model of the engineered structure further comprises producing the completed model to include a shape for each of the segments.

4. The computer implemented method of claim 2, wherein the completed model includes a plurality of the segments each having different thicknesses from one another.

5. The computer implemented method of claim 1, wherein the object function results in boundary lengths for each of the segments, the method further comprising:
(h) determining if the converged objective function value corresponds to boundary lengths within an acceptable boundary length range;
(i) if the converged objective function value corresponds to boundary lengths within the acceptable boundary length range, determining if a lower bound of the boundary lengths reaches a lower bound of the acceptable boundary length range;
(j) if the lower bound of the boundary lengths does not reach the lower bound of the acceptable boundary length range, then adjusting the lower bound of the boundary lengths and performing (h)-(j) again; and
(k) if the lower bound of the boundary lengths corresponds to the lower bound of the acceptable boundary length range, producing the completed model of the engineered structure to additionally include the boundary lengths for each of the segments.

6. The computer implemented method of claim 5, wherein determining if the converged objective function value corresponds to the boundary lengths within the acceptable boundary length range, at (h), comprises applying a mesh filter to the material density values.

7. The computer implemented method of claim 6, further comprising applying the mesh filter to the material density values to reduce a checker board pattern that emerges when an outline length is excluded from the boundary lengths using a differentiable approximate function of a step function.

8. The computer implemented method of claim 7, wherein the differentiable approximate step function is a sigmoid function, Fourier series, or a polynomial expression.

9. The computer implemented method of claim 5, further comprising applying a boundary length minimization to the material density values to reduce the boundary lengths between segments having different thicknesses.

10. An apparatus comprising:
one or more processing units and one or more memories storing instructions that when executed by the one or more processing units, cause the one or more processing units to:
(a) receive a design model for an engineered structure formed of segments having different thicknesses, the design model including (i) a finite element model of a spatial domain wherein the engineered structure is contained and (ii) an objective function to be optimized,
wherein the finite element model defines an adjustable material density that represents material density values for each of the segments forming the engineered structure,
wherein the objective function defines (i) an external load bearing ability of the engineered structure, as a function of a material density value, and (ii) segment boundary lengths for boundary regions between adjacent segments forming the engineering structure, as a function of a material density value;
(b) execute a finite element method to solve equilibrium conditions for the finite element model, wherein the equilibrium conditions define an acceptable range of material density values for each of the segments, where the acceptable range of material density values correspond to an acceptable range of thicknesses for each of the segments;
(c) determine a converged objective function value for the finite element model;
(d) determine if the converged objective function value results in material density values for each of segment that correspond to the acceptable range of thicknesses;
(e) if the converged objective function value corresponds to the acceptable range of thicknesses, determine if a lower bound of the material density values of the segments reaches a lower bound of the acceptable range of material density values;
(f) if the lower bound of the material density values does not reach the lower bound of the acceptable range of material density values, then adjust the lower bound of the material density values until the lower bound of the acceptable range is reached and perform (b)-(f) until the lower bound of the material density values corresponds to the lower bound of the acceptable range of material density values; and
(g) if the converged objective function value is given by material density values that correspond to the acceptable range of material density values and if the lower bound of the material density values corresponds to the lower bound of the acceptable range, then produce a completed model of the engineered structure, the completed model including the segments and thicknesses of each of the segments.

11. The apparatus of claim 10, wherein the instructions that when executed by the one or more processing units, cause the one or more processing units to produce the completed model of the engineered structure further comprises instructions to produce the completed model to include segment boundary lengths for the boundary regions between adjacent segments.

12. The apparatus of claim 11, wherein the instructions that when executed by the one or more processing units, cause the one or more processing units to produce the completed model of the engineered structure further comprises instructions to produce further comprises instructions to produce the completed model to include a shape for each of the segments.

13. The apparatus of claim 11, wherein the completed model includes a plurality of the segments each having different thicknesses from one another.

14. The apparatus of claim 10, wherein the object function includes in boundary lengths for each of the segments, wherein the one or more memories store instructions that further cause the one or more processing units to:
(h) determine if the converged objective function value corresponds to boundary lengths within an acceptable boundary length range;
(i) if the converged objective function value corresponds to boundary lengths within the acceptable boundary length range, determine if a lower bound of the boundary lengths reaches a lower bound of the acceptable boundary length range;
(j) if the lower bound of the boundary lengths does not reach the lower bound of the acceptable boundary length range, then adjust the lower bound of the boundary lengths and perform (h)-(j) again; and
(k) if the lower bound of the boundary lengths corresponds to the lower bound of the acceptable boundary length range, producing the completed model of the engineered structure to additionally include the boundary lengths for each of the segments.

15. The apparatus of claim 14, wherein the instructions that when executed by the one or more processing units, cause the one or more processing units to determine if the converged objective function value corresponds to the boundary lengths within the acceptable boundary length range, at (h), comprises instructions to apply a mesh filter to the material density values.

16. The apparatus of claim 15, wherein the one or more memories store instructions that further cause the one or more processing units to apply the mesh filter to the material density values to reduce a checker board pattern that emerges when an outline length is excluded from the boundary lengths using a differentiable approximate function of a step function.

17. The apparatus of claim 16, wherein the differentiable approximate step function is a sigmoid function, Fourier series, or a polynomial expression.

18. The apparatus of claim 14, wherein the one or more memories store instructions that further cause the one or more processing units to apply a boundary length minimization to the material density values to reduce the boundary lengths between segments having different thicknesses.
